(19) United States
(12) Patent Application Publication
(10) Pub. No.: US 2002/0166271 A1
(43) Pub. Date: Nov. 14, 2002

(54) Configurable numbering device

(76) Inventor: Brandon S. Johnston, Longview, TX (US)

Correspondence Address: Brandon S. Johnston, 3112 Gilmer Road, Longview, TX, 75605, US

(21) Appl. No.: 09/735,702

(22) Filed: Dec. 12, 2000

(51) Int. Cl. G09F 3/04; G09F 15/00

(52) U.S. Cl. 40/450; 40/607

(57) ABSTRACT

A configurable numbering device includes a body portion having one or more numbering sections where each numbering section having reflective material in a number 8 configuration and a plurality of strips are adapted to overlay portions on the number 8 configuration so that any number zero through nine may appear in each numbering section. In an alternate embodiment, the device includes a plurality of reflective strips adapted to overlay portions on the number 8 configuration so that any number zero through nine may appear in each numbering section. In another configuration, the reflective strips may be replaced with an internal lighting source. The device may also include a wedge shaped portion for insertion into the ground, or may be adapted to a mailbox configuration. In addition, the device includes a message section wherein words, numbers, symbols or a combination thereof may be displayed, including advertising.

### SUMMARY OF THE INVENTION

A primary object of the present invention is to provide a numbering device that may be configurable to a variety of situations.

A related object of the present invention is to provide a configurable numbering device that avoids the need to purchase separate, individual numbers zero through nine to display a number or string of numbers.

In accordance with another preferred embodiment of the present invention, a configurable number device comprises a body portion having one or more numbering sections; each numbering section having reflective material in a number 8 configuration and a plurality of strips adapted to overlay portions on the number 8 configuration so that any number zero through nine may appear in each numbering section.

In accordance with another embodiment of the present invention, a configurable numbering device comprises a body portion having one or more numbering sections; each numbering section having material in a number 8 configuration and a plurality of reflective strips adapted to overlay portions on the number 8 configuration so that any number zero through nine may appear in each numbering section.

In accordance with another embodiment of the present invention, a configurable numbering device comprises a body portion having one or more numbering sections; a light source within the body; each numbering section having material in a number 8 configuration; and a plurality of strips adapted to overlay portions on the number 8 configuration so that any number zero through nine may appear in each numbering section.

In accordance with another embodiment of the present invention, a configurable numbering device comprises a body portion having one or more numbering sections; a light source within the body; each numbering section having material in a number 8 configuration; and a plurality of strips adapted to be removed form portions on the number 8 configuration so that any number zero through nine may appear in each numbering section.

Other advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIGS. 1 is a perspective view of a configurable numbering device in accordance with a preferred embodiment of the present invention.

FIG. 2 is a perspective view of the device of FIG. 1 installed in a lawn.

FIG. 3 is a perspective view of the device of FIG. 1 installed on the side of a mailbox.

### DETAILED DESCRIPTION OF THE PREFERRED EMBODIMENTS

Detailed descriptions of the preferred embodiment are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

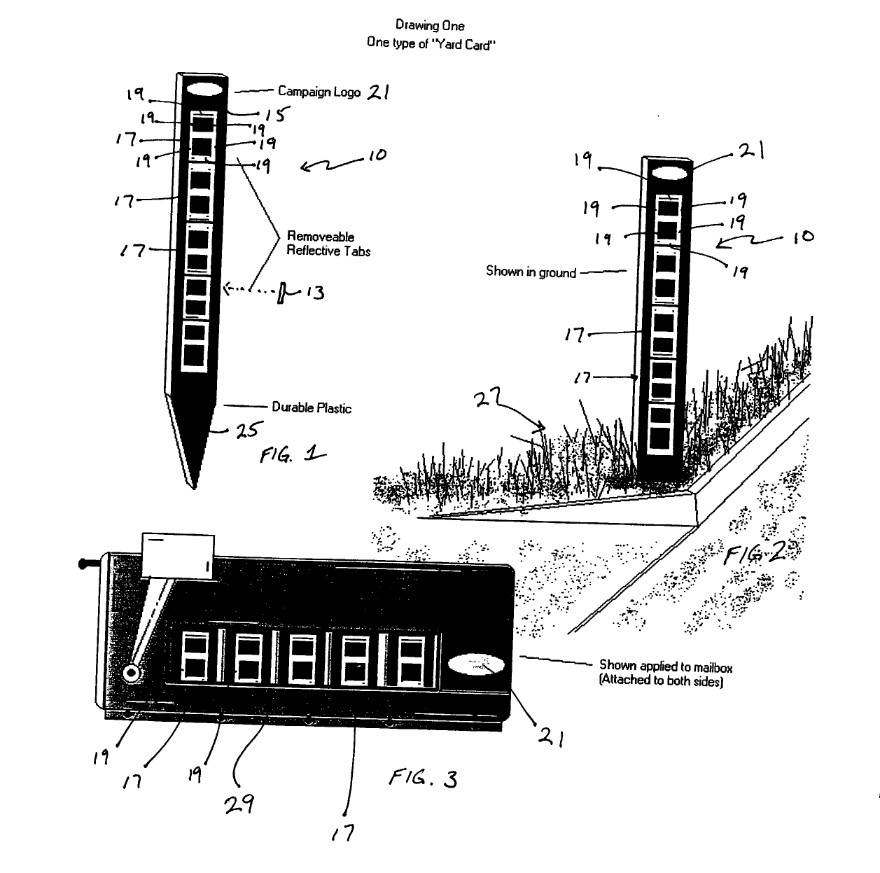

Referring now to the drawings and initially to FIG. 1, there is illustrated a configurable numbering device according to a preferred embodiment of the present invention. Numbering device 10 includes a body portion 15, preferably made of durable plastic, but may be of any suitable material. Body portion 15 includes numbering sections 17, each having a plurality of strips in a figure 8 orientation. In such an orientation, a subset of strips 19 on each section may be selected so that any number from zero to nine appears. In the illustrated embodiment, strips 19 are a reflective material well know in the art. Each reflective strip 19 may have a removable overlay 13 so that upon positioning or removing a strip 19 in section 17, a number may appear through reflection, such as when car lights drive past. It will be appreciated that any number of sections 17 may be employed, though five are illustrated in FIG. 1.

In an alternate configuration, each section 17 may be adapted to removably hold a strip 19 of reflective material. In such a configuration, by placing an appropriate combination of reflective strips in each section 17, any number from zero to nine may appear.

In another alternate configuration, body 15 may house a light source. In such a configuration, each section 17 will be provided with a plurality of strips that, upon removal, will allow light to shine through the removed space, thereby any number from zero through nine may appear. The power source for the light source in body 15 may be by battery, solar power, electric cord to an electric power source, etc.

In any configuration, body 15 is also provided with a message section 21, where any number, letter, symbol, or combination thereof may appear. It will be appreciated that while section 21 is show at the upper portion of body 15, it may appear anywhere on body 15 as is imaginable and appropriate for the circumstances. In the illustrated embodiment, message section 21 is shown with a politically oriented message on the form of a logo.

In the illustrated embodiment of FIG. 1, body 15 includes wedge shaped portion 25 to aid in the insertion of device 10 into a standard lawn or other ground material. Turning to FIG. 2, body 15 is shown with wedge shaped portion inserted into a grass covered lawn 27.

Other applications of the configurable numbering device are also possible and included within the scope and spirit of the present invention. One such alternate configuration is shown in FIG. 3 where the configurable numbering device 10 is applied to a side of mailbox 29. It will be appreciated that both sides of a mailbox 29 may have the device 10 attached thereto. Further, it can be appreciated that the entire mailbox may be a configurable numbering device of the present invention with the mailbox body 29 acting as body 15 of the embodiment illustrated in FIGS. 1 and 2.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A configurable numbering device comprising:
a body portion having one or more numbering sections;
each numbering section having reflective material in a number 8 configuration
a plurality of strips adapted to overlay portions on the number 8 configuration so that any number zero through nine may appear in each numbering section.

2. A configurable numbering device comprising:
a body portion having one or more numbering sections;
each numbering section having material in a number 8 configuration
a plurality of reflective strips adapted to overlay portions on the number 8 configuration so that any number zero through nine may appear in each numbering section.

3. A configurable numbering device comprising:
a body portion having one or more numbering sections;
a light source within the body;
each numbering section having material in a number 8 configuration;
a plurality of strips adapted to overlay portions on the number 8 configuration so that any number zero through nine may appear in each numbering section.

4. A configurable numbering device comprising:
a body portion having one or more numbering sections;
a light source within the body;
each numbering section having material in a number 8 configuration;
a plurality of strips adapted to be removed form portions on the number 8 configuration so that any number zero through nine may appear in each numbering section.

5. A configurable numbering device as claimed in claim 1 further comprising a wedge shaped portion to assist inserting the device into the ground.

6. A configurable numbering device as claimed in claim 2 further comprising a wedge shaped portion to assist inserting the device into the ground.

7. A configurable numbering device as claimed in claim 1 further comprising a message section wherein words, numbers, symbols are a combination thereof may be displayed, including advertising.

8. A configurable numbering device as claimed in claim 2 further comprising a message section wherein words, numbers, symbols a re a combination thereof may be displayed, including advertising.

9. A configurable numbering device as claimed in claim 3 further comprising a message section wherein words, numbers, symbols are a combination thereof may be displayed, including advertising.

10. A configurable numbering device as claimed in claim 4 further comprising a message section wherein words, numbers, symbols are a combination thereof may be displayed, including advertising.
